(19) United States
(12) Patent Application Publication
(10) Pub. No.: US 2012/0148924 A1
(43) Pub. Date: Jun. 14, 2012

(54) POWER STORAGE DEVICE AND METHOD FOR MANUFACTURING THE POWER STORAGE DEVICE

(75) Inventors: Kiyofumi Ogino, Isehara (JP); Kuniharu Nomoto, Atsugi (JP); Teppei Oguni, Atsugi (JP); Mako Motoyoshi, Hadano (JP)

(73) Assignee: SEMICONDUCTOR ENERGY LABORATORY CO., LTD., Atsugi-shi (JP)

(21) Appl. No.: 13/308,867

(22) Filed: Dec. 1, 2011

(30) Foreign Application Priority Data
Dec. 10, 2010 (JP) 2010-275838

(51) Int. Cl. H01M 10/056; H01G 9/022; H01G 9/028; H01M 10/04

(52) U.S. Cl. 429/341; 429/207; 29/623.1; 29/623.5; 29/25.03; 361/527

(57) ABSTRACT

To provide a power storage device having a solid electrolyte, in which a charge-discharge capacity can be increased, and a method for manufacturing the power storage device. The power storage device includes a positive electrode, a negative electrode, and an electrolyte provided between the positive electrode and the negative electrode, and the electrolyte includes an ion-conductive high molecular compound, an inorganic oxide, and a lithium salt, and the inorganic oxide is included in the electrolyte at more than 30 wt % and 50 wt % or less to the total of the ion-conductive high molecular compound and the inorganic oxide.

### TECHNICAL FIELD

The present invention relates to a power storage device and a method for manufacturing the power storage device.

Note that the power storage device indicates all elements and devices which have a function of storing power.

### BACKGROUND ART

In recent years, the development of power storage devices such as a lithium-ion secondary battery and a lithium-ion capacitor has been conducted.

In addition, for power storage devices using solid electrolytes, the use of a high molecular compound with high ion conductivity in which lithium salt is dissolved in polyethylene oxide, for an electrolyte, has been studied.

Further, a power storage device has been proposed, in which in order to increase the ion conductivity of such a high molecular compound with high ion conductivity, a mesoporous filler made of metal oxide is provided as an ion-conduction path between electrodes, and the inside of the mesoporous filler and a space between the mesoporous fillers are filled with a high molecular compound with high ion conductivity (for example, Patent Document 1).

### REFERENCE

Patent Document 1: Japanese Published Patent Application No. 2006-40853

### DISCLOSURE OF INVENTION

However, although the conductivity of an electrolyte can be increased by provision of the mesoporous filler made of metal oxide, working as an ion conduction path between electrodes, the charge-discharge capacity of the power storage device is not improved yet.

In view of the above, an object of one embodiment of the present invention is to provide a power storage device whose charge-discharge capacity can be larger, using solid electrolytes, and a method for manufacturing the power storage device.

One embodiment of the present invention is a power storage device including a positive electrode, a solid electrolyte, and a negative electrode, in which the electrolyte includes an ion-conductive high molecular compound, an inorganic oxide, and an alkali metal salt, and the inorganic oxide is included in the electrolyte at more than 30 wt % and 50 wt % or less, preferably from 33 wt % to 50 wt %, to the total of the high molecular compound and the inorganic oxide.

Further, one embodiment of the present invention is a power storage device including a positive electrode, a solid electrolyte, and a negative electrode, in which the electrolyte includes an ion-conductive high molecular compound, an inorganic oxide, and an alkali metal salt, and in an active material layer included in the positive electrode or the negative electrode, a high molecular compound having a softening point lower than or equal to the softening point of the ion-conductive high molecular compound included in the electrolyte is included as a binder. Note that an ion-conductive high molecular compound may be used as a binder in the active material layer included in the positive electrode or the negative electrode. Alternatively, as the binder, an ion-conductive high molecular compound formed of the same material as the ion-conductive high molecular compound included in the electrolyte may be included.

One embodiment of the present invention is a method for manufacturing a power storage device in such a way that an ion-conductive high molecular compound, an inorganic oxide, and an alkali metal salt are mixed, are applied on a substrate, and dried so that an electrolyte is formed; then, the electrolyte is separated off from the substrate; the separated electrolyte is sandwiched between the positive electrode and the negative electrode; one cycle of charge and discharge between the positive electrode and the negative electrode is conducted at temperatures higher than a softening point of the ion-conductive high molecular compound so that the electrolyte, a first active material layer, and a second active material layer are adhered to each other.

A typical example of ion-conductive high molecular compounds includes polyalkylene oxide. Typical examples of polyalkylene oxide include polyethylene oxide, polypropylene oxide, polyphenylene oxide, and the like.

An inorganic oxide included in the electrolyte is one or more selected from the group consisting of silicon oxide, titanium oxide, zirconium oxide, aluminum oxide, zinc oxide, iron oxide, cerium oxide, magnesium oxide, antimony oxide, germanium oxide, lithium oxide, graphite oxide, barium titanate, and lithium metasilicate.

Typical examples of an alkali metal salt include lithium salt, sodium salt, and the like. Typical examples of lithium salt include LiCF₃SO₃, LiPF₆, LiBF₄, LiClO₄, LiSCN, LiN(CF₃SO₂)₂ (also referred to as LiTFSI), LiN(C₂F₅SO₂)₂ (also referred to as LiBETI), and the like.

In accordance with one embodiment of the present invention, a power storage device with high charge-discharge capacity at temperatures lower than a softening point of an ion-conductive high molecular compound included in an electrolyte can be manufactured.

### BRIEF DESCRIPTION OF DRAWINGS

In the accompanying drawings:

FIG. 1 is a cross-sectional view illustrating a power storage device;

FIG. 2 is a diagram describing a method for manufacturing a power storage device;

FIG. 3 is a diagram describing a method for forming an electrolyte in a power storage device;

FIGS. 4A to 4D are diagrams illustrating a method for forming an electrolyte in a power storage device;

FIGS. 5A and 5B are perspective views of an application mode of a power storage device;

FIG. 6 is a diagram illustrating an example of a structure of a wireless power feeding system;

FIG. 7 is a diagram illustrating an example of a structure of a wireless power feeding system;

FIGS. 8A and 8B are graphs showing charge-discharge characteristics of secondary batteries;

FIG. 9 is a graph showing charge-discharge characteristics of a secondary battery;

FIG. 10 is a graph showing charge-discharge characteristics of a secondary battery;

FIG. 11 is a graph showing charge-discharge characteristics of a secondary battery;

FIG. 12 is a graph showing charge-discharge characteristics of a secondary battery, and

FIGS. 13A to 13D are graphs showing impedances of secondary batteries.

### BEST MODE FOR CARRYING OUT THE INVENTION

Hereinafter, embodiments of the present invention will be described with reference to the drawings. Note that the invention is not limited to the following description, and it will be easily understood by those skilled in the art that various changes and modifications can be made without departing from the spirit and scope of the invention. Therefore, the present invention should not be construed as being limited to the following description of the embodiments and examples. In description with reference to the drawings, in some cases, the same reference numerals are used in common for the same portions in different drawings. Further, in some cases, the same hatching patterns are applied to similar parts, and the similar parts are not necessarily designated by reference numerals.

### Embodiment 1

In this embodiment, a power storage device and a method for manufacturing the power storage device, which are aspects of the present invention, will be described.

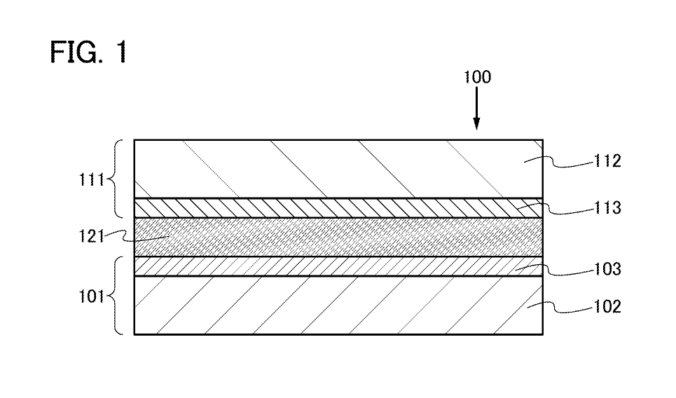

One embodiment of a power storage device of this embodiment is described with reference to FIG. 1. Here, a structure of a secondary battery is described below as a power storage device.

A lithium-ion secondary battery using a metal oxide containing lithium has a large capacity and high safety as a secondary battery. Here, the structure of a lithium-ion secondary battery that is a typical example of a secondary battery is described.

FIG. 1 is a cross-sectional view of a power storage device 100.

The power storage device 100 includes a negative electrode 101, a positive electrode 111, and a solid electrolyte (hereinafter, referred to as an electrolyte 121) sandwiched between the negative electrode 101 and the positive electrode 111. In addition, the negative electrode 101 may include a negative electrode current collector 102 and a negative electrode active material layer 103. The positive electrode 111 may include a positive electrode current collector 112 and a positive electrode active material layer 113. In addition, the electrolyte 121 is in contact with a negative electrode active material layer 103 and a positive electrode active material layer 113.

The negative electrode current collector 102 and the positive electrode current collector 112 are connected to different external terminals. In addition, the negative electrode 101, the electrolyte 121, and the positive electrode 111 are covered with an exterior material not illustrated.

Note that the “active material” refers to a material; that relates to insertion and elimination of ions as carriers and does not include a carbon layer obtained from glucose, or the like. When an electrode such as a positive electrode or a negative electrode is formed by a coating method as described later, an active material layer is formed over the current collector using those obtained by mixing other materials such as a conduction auxiliary agent, a binder, and a solvent, together with the active material covered with the carbon layer. Thus, the terms “the active material” and “the active material layer” are distinguished.

First, the electrolyte 121 included in the power storage device 100 in this embodiment is described.

The electrolyte 121 includes an ion-conductive high molecular compound, an inorganic oxide, and an alkali metal salt. Note that the electrolyte 121 may have a plurality of ion-conductive high molecular compounds. Alternatively, the electrolyte 121 may include a plurality of inorganic oxides. Alternatively, the electrolyte 121 may include a plurality of alkali metal salts.

A typical example of the ion-conductive high molecular compound is polyalkylene oxide having a molecular weight of ten thousand to a million. Typical examples of polyalkylene oxide include polyethylene oxide, polypropylene oxide, polyphenylene oxide, and the like.

Examples of inorganic oxides include silicon oxide, titanium oxide, zirconium oxide, aluminum oxide, zinc oxide, iron oxide, cerium oxide, magnesium oxide, antimony oxide, germanium oxide, lithium oxide, graphite oxide, barium titanate, lithium metasilicate, and the like.

The diameter of a particle of the inorganic oxide is preferably from 50 nm to 10 μm.

Examples of alkali metal salt include lithium salt, sodium salt, and the like. Typical examples of lithium salt include LiCF₃SO₃, LiPF₆, LiBF₄, LiClO₄, LiSCN, LiN(CF₃SO₂)₂, LiN(C₂F₅SO₂)₂, and the like. Typical examples of sodium salt include NaClO₄, NaPF₆, NaBF₄, NaCF₃SO₃, NaN(CF₃SO₂)₂, NaN(C₂F₅SO₂)₂, NaC(CF₃SO₂)₃, and the like.

In the electrolyte, the ion-conductive high molecular compound, the inorganic oxide, and the alkali metal salt are mixed at 15 wt % to 65 wt %, 12 wt % to 80 wt %, 5 wt % to 50 wt %, respectively, so as to be included at total 100 wt %. In addition, the content of the inorganic oxide to the total of the ion-conductive high molecular compound and the inorganic oxide is more than 30 wt % and 50 wt % or less, preferably from 33 wt % to 50 wt %. Thus, the crystallization of the ion-conductive high molecular compound included in the electrolyte can be suppressed, so that the ion conductivity of the electrolyte can be enhanced. As a result, transfer of mobile ions between the positive electrode and the negative electrode can be easy, so that charge-discharge capacity can be increased. In addition, a high charge-discharge capacity can be obtained at temperatures lower than a softening point of the ion-conductive high molecular compound included in the electrolyte.

Next, the negative electrode 101 included in the power storage device 100 in this embodiment is described.

As the negative-electrode current collector 102, a material having high conductivity such as copper, stainless steel, iron, or nickel can be used. The negative electrode current collector 102 can have a shape such as a foil shape, a plate shape, or a net shape as appropriate.

The negative electrode active material layer 103 is formed using a material capable of lithium-ion occlusion and emission. As the negative electrode active material layer 103, lithium, aluminum, graphite, silicon, tin, germanium, or the like is typically used. Note that the negative electrode current collector 102 may be omitted and the negative electrode active material layer 103 alone may be used as the negative electrode. The theoretical lithium occlusion capacity of germanium, silicon, lithium, and aluminum is larger than that of graphite. When the occlusion capacity is large, charge and discharge can be performed sufficiently even in a small area and a function as a negative electrode can be obtained; therefore, cost reduction and miniaturization of a secondary battery can be realized. However, in the case of silicon or the like, the volume is approximately quadrupled due to lithium occlusion; therefore, the probability that the material itself gets vulnerable should be considered.

Note that the negative electrode active material layer 103 may be predoped with lithium. As a predoping method of lithium, a lithium layer may be formed on a surface of the negative electrode active material layer 103 by a sputtering method. Alternatively a lithium foil is provided on the surface of the negative electrode active material 103, whereby the negative electrode active material layer 103 can be predoped with lithium.

A desired thickness of the negative electrode active material layer 103 is selected from the range of 20 μm to 100 μm.

Note that the negative electrode active material layer 103 may include a binder and a conduction auxiliary agent.

As the binder, polysaccharides such as starch, carboxymethyl cellulose, hydroxypropyl cellulose, regenerated cellulose, and diacetyl cellulose; vinyl polymers such as polyvinylchloride, polyethylene, polypropylene, polyvinyl alcohol, polyvinyl pyrrolidone, polytetrafluoroethylene, polyvinyliden fluoride, ethylene-propylene-diene monomer (EPDM) rubber, sulfonated EPDM rubber, styrene-butadiene rubber, butadiene rubber, and fluorine rubber; polyether such as polyethylene oxide; and the like can be given.

As the conduction auxiliary agent, a material which is itself an electron conductor and does not cause chemical reaction with other materials in a power storage device may be used. For example, carbon-based materials such as graphite, carbon fiber, carbon black, acetylene black, and VGCF (registered trademark); metal materials such as copper, nickel, aluminum, and silver; and powder, fiber, and the like of mixtures thereof can be given. The conduction auxiliary agent is a material that promotes conduction between active materials; it is provided between separate active materials so as to make conduction between the active materials.

Next, the positive electrode 111 included in the power storage device 100 in this embodiment is described.

As the positive electrode current collector 112, a material having high conductivity such as platinum, aluminum, copper, titanium, or stainless steel can be used. The positive electrode current collector 112 can have a shape such as a foil shape, a plate shape, or a net shape as appropriate.

Examples of materials used for the positive electrode active material layer 113 include LiFeO₂, LiCoO₂, LiNiO₂, LiMn₂O₄, LiFePO₄, Li₃Fe₂(PO₄)₃, LiCoPO₄, LiNiPO₄, LiMn₂PO₄, Li₁₋ₓ₁Fe_{y1}M_{1-y1}PO₄ (x1 is from 0 to 1; M is one or more of Mn, Co, and Ni; and y₁ is 0 or more and less than 1), Li₂FeSiO₄, Li₂MnSiO₄, V₂O₅, Cr₂O₅, MnO₂, and other materials.

As the thickness of the positive electrode active material layer 113, a desired thickness is selected from the range of 20 μm to 100 μm. It is preferable to adjust the thickness of the positive electrode active material layer 113 as appropriate so that cracks and separation do not occur.

In addition, the positive electrode active material layer 113 may include a binder and a conduction auxiliary agent, similarly to the negative electrode active material layer 103. The binders and the conduction auxiliary agents listed for those of the negative electrode active material layer 103 can be used as appropriate for the positive electrode active material layer 113.

A lithium-ion secondary battery has a small memory effect, a high energy density, a large capacity, and further a high output voltage. Thus, the size and weight of the lithium ion secondary battery can be reduced. Further, the lithium ion secondary battery does not easily degrade due to repetitive charge and discharge and can be used for a long time, so that cost can be reduced. In addition, in this embodiment, since the electrolyte includes both an inorganic oxide and an ion-conductive high molecular compound, crystallization of the ion-conductive high molecular compound is suppressed, so that the ion conductivity of the electrolyte is increased. As a result, transfer of mobile ions between the positive electrode and the negative electrode can be easy, so that a charge-discharge capacity can be increased.

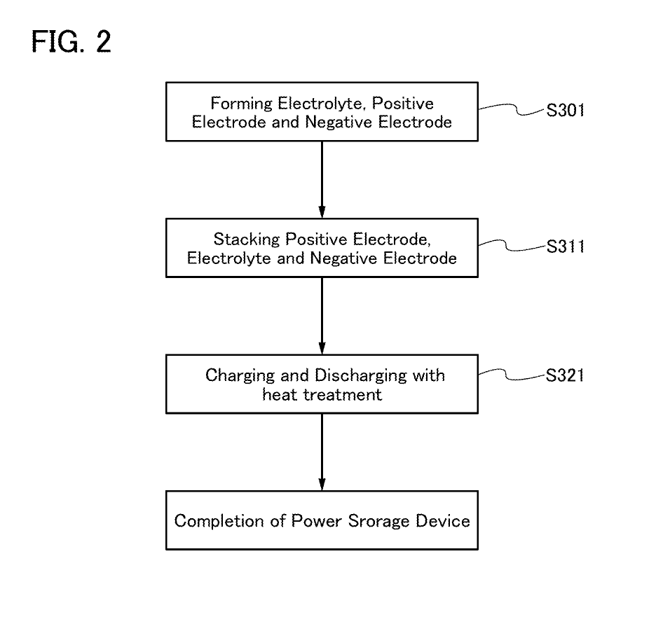

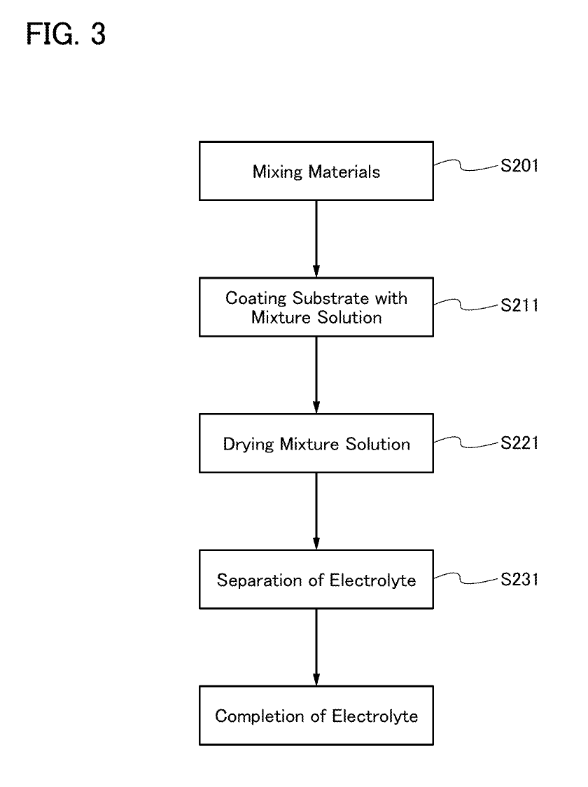

Next, a method for manufacturing the power storage device 100 described in this embodiment is described with reference to FIG. 2 and FIG. 3.

As described in a step S301 in FIG. 2, the electrolyte, the positive electrode, and the negative electrode are formed.

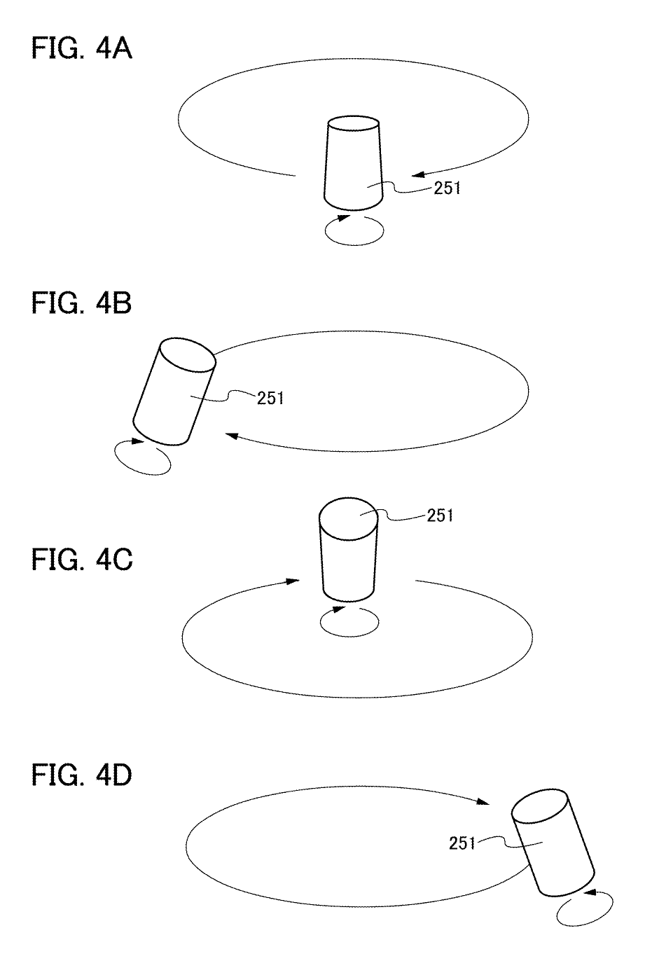

First, a method for forming the electrolyte is described with reference to FIG. 3 and FIGS. 4A to 4D.

An ion-conductive high molecular compound, an inorganic oxide, and an alkali metal salt are weighed as materials of the electrolyte, and a solvent is weighed. As the solvent, dehydrated acetonitrile, lactic acid ester, N-methyl-2-pyrrolidone (NMP), or the like can be used.

Here, polyethylene oxide; a mixture of silicon oxide, titanium oxide, and aluminum oxide; and LiTFSI are used as the ion-conductive high molecular compound; the inorganic oxide; and the alkali metal salt, respectively. Dehydrated acetonitrile is used as the solvent.

Next, as described in a step S201 in FIG. 3, materials of the electrolyte and the solvent are mixed, so that a mixture solution is obtained.

Here, one mode in which the materials of the electrolyte are mixed evenly in the step S201 is described with reference to FIGS. 4A to 4D. At this time, the materials in a container can be agitated evenly with use of an agitator which is capable of rotating and revolving at the same time.

As illustrated in FIG. 4A, a container 251 where materials of the electrolyte are put is installed in the agitator, and the container 251 is revolved clockwise while the container 251 is being rotated. FIG. 4B, FIG. 4C, and FIG. 4D illustrate states where the container 251 is revolved at 90 degree, 180 degree, and 270 degree, respectively from the state illustrated in FIG. 4A. In this manner, by rotating and revolving the container 251 at the same time, the materials can be evenly mixed, without air included at the time of agitating the materials of the electrolyte. Note that clockwise revolution is adopted here, but counterclockwise revolution may be adopted. In addition, the rotation may be either clockwise or counterclockwise as appropriate.

Next, as described in a step S211 in FIG. 3, the mixture solution is applied on a substrate. The substrate may be an appropriate one having a heat resistance higher than the temperature of a later drying step. Typical examples of the substrate include a glass substrate, a wafer substrate, a plastic substrate, and the like. In this case, a glass substrate is used as the substrate. Then, the substrate is set in an automatic coating device and the substrate is coated with the mixture solution.

Next, as described in a step S221 in FIG. 3, the mixture solution applied on the substrate is dried. The mixture solution may be heated at temperatures which allow the solvent to vaporize. Here, the solvent is vaporized in a circulation dryer for drying. In this manner, the solid electrolyte is formed on the substrate.

Next, as described in a step S231 in FIG. 3, the electrolyte is separated off from the substrate. Since the inorganic oxide is mixed in the electrolyte, the electrolyte can be easily separated off the substrate. At this time, the electrolyte is separated off from the substrate with use of tweezers.

After that, another drying treatment may be performed. In this manner, moisture, solvent, and the like can be removed from the electrolyte.

Through the above steps, the electrolyte can be formed.

Next, a method for forming the negative electrode is described.

The negative electrode active material layer 103 is formed over the negative electrode current collector 102 by a coating method, a sputtering method, an evaporation method, or the like, and thereby the negative electrode is formed. Alternatively, for the negative electrode, a foil, a plate, or a mesh of lithium, aluminum, graphite, and silicon can be used. Alternatively, graphite predoped with lithium can be used. In this embodiment, graphite predoped with lithium is used as the negative electrode.

Next, a method for forming the positive electrode is described.

The positive electrode active material layer 113 is formed over the positive electrode current collector 112 by a coating method, a sputtering method, an evaporation method, or the like, and thereby the positive electrode is formed.

Next, as described in a step S311 in FIG. 2, the positive electrode, the electrolyte, and the negative electrode are stacked in this order, and the electrolyte is sandwiched with the positive electrode and the negative electrode. In this manner, a power storage cell is formed.

Next, as described in a step S321, while the power storage cell is being heated, one cycle of charge and discharge is conducted. At this time, the charge and discharge is conducted while heat treatment is being conducted at temperatures higher than the softening point of the ion-conductive high molecular compound included in the electrolyte. Through the above steps, a power storage device is completed.

In the power storage cell formed in this embodiment, since the one cycle of charge and discharge is conducted while heat treatment is being conducted at temperatures higher than the softening point of the ion-conductive high molecular compound included in the electrolyte, the adhesiveness between the electrolyte and the positive and the negative electrodes is strengthened. As a result, the resistance at the interface between the electrolyte and each of the positive electrode and negative electrode can be reduced. In addition, since the inorganic oxide is mixed in the electrolyte at more than 30 wt % and 50 wt % or less, preferably from 33 wt % to 50 wt % with respect to the total of the ion-conductive high molecular compound and the inorganic oxide, crystallization of the ion-conductive high molecular compound included in the electrolyte can be suppressed, so that the ion conductivity of the electrolyte can be increased. As a result, transfer of mobile ions between the positive electrode and the negative electrode can be easy so that charge-discharge capacity can be increased. In addition, a high charge-discharge capacity can be obtained at even temperatures lower than the softening point of the ion-conductive high molecular compound included in the electrolyte.

### Embodiment 2

In this embodiment, in order to increase the charge-discharge capacity as compared with the power storage device described in Embodiment 1, at least one of the positive electrode and the negative electrode in the power storage device in Embodiment 1, is formed by a coating method, and a high molecular compound having a softening point lower than or equal to the softening point of the ion-conductive high molecular compound included in the electrolyte is used as a binder of either the positive electrode or the negative electrode or the both.

The power storage device described in this embodiment includes a positive electrode, an electrolyte, and a negative electrode. For the electrolyte, the electrolyte exemplified in Embodiment 1 can be used as appropriate.

In addition, a negative electrode active material layer constituting a part of the negative electrode includes particles of aluminum, graphite, silicon, tin, germanium, or the like serving as an active material, a conduction auxiliary agent, and a binder. As the binder, a high molecular compound having a softening point lower than or equal to that of the ion-conductive high molecular compound included in the electrolyte is used.

In addition, the positive electrode active material layer constituting a part of the positive electrode includes a conduction auxiliary agent, a binder, and an active material such as LiFeO₂, LiCoO₂, LiNiO₂, LiMn₂O₄, LiFePO₄, Li₃Fe₂(PO₄)₃, LiCoPO₄, LiNiPO₄, LiMn₂PO₄, Li₁₋ₓ₁Fe_{y1}M_{1-y1}PO₄ (x1 is 0 or more and 1 or less, M is one or more of Mn, Co, and Ni, and y₁ is 0 or more and less than 1), Li₂FeSiO₄, Li₂MnSiO₄, V₂O₅, Cr₂O₅, or MnO₂. Further, a high molecular compound having a softening point lower than or equal to the softening point of the ion-conductive high molecular compound included in the electrolyte is used as a binder.

An example of a high molecular compound having a softening point lower than or equal to the softening point of the ion-conductive high molecular compound included in the electrolyte is a styrene-butadiene copolymer.

Alternatively, instead of the high molecular compound having a softening point lower than or equal to the softening point of the ion-conductive high molecular compound included in the electrolyte, an ion-conductive high molecular compound which has a softening point lower than or equal to the softening point of the ion-conductive high molecular compound included in the electrolyte may be used as a binder. In this case, the ion-conductive high molecular compound included in the electrolyte and the binder included in the positive electrode active material layer may be the same ion-conductive high molecular compound or different ion-conductive high molecular compounds.

Note that in this embodiment, in at least one of the positive electrode active material layer and the negative electrode active material layer, it is preferable to use, as a binder, a high molecular compound having a softening point lower than or equal to the softening point of the ion-conductive high molecular compound included in the electrolyte.

Next, a method for manufacturing the power storage device described in this embodiment will be described with reference to FIG. 2.

As described in the step S301 of FIG. 2, an electrolyte, a positive electrode, and a negative electrode are formed. The electrolyte can be formed in a manner similar to that in Embodiment 1.

Next, methods for forming the negative electrode and the positive electrode are described.

First, the method for forming the negative electrode in this embodiment is described.

A negative electrode active material, a conduction auxiliary agent, a binder, and a solvent are mixed. As the binder, a high molecular compound having a softening point lower than or equal to the softening point of the ion-conductive high molecular compound included in the electrolyte, as described in this embodiment, can be used as appropriate.

The negative electrode active material, the conduction auxiliary agent, and the binder are mixed at 80 wt % to 96 wt %, 2 wt % to 10 wt %, and 2 wt % to 10 wt %, respectively, so as to be 100 wt % in total. Further, an organic solvent, the volume of which is approximately the same as that of the mixture of the active material, the conduction auxiliary agent, and the binder, is mixed in the mixture to form slurry. The proportions of the active material, the conduction auxiliary agent, and the binder are preferably adjusted as appropriate in such a manner that, for example, when the active material and the conduction auxiliary agent have low adhesiveness in the active material layer to be formed later, the amount of binder is increased, and when the resistance of the active material is high, the amount of the conduction auxiliary agent is increased.

Next, the slurry is applied on the negative electrode current collector by a cast method, a coating method, or the like, and the applied slurry is spread thinly and extended by a roller press machine, so that the thickness is made uniform. Then, treatment such as vacuum drying (10 Pa or lower) or heat drying (150 to 280° C.) is conducted, and thereby the negative electrode active material layer is formed on the negative electrode current collector.

In addition, the positive electrode is formed in a manner similar to that of the negative electrode. In other words, a positive electrode active material, a conduction auxiliary agent, a binder, and a solvent are mixed to form slurry, then the slurry is applied on the positive electrode current collector, and dried, so that the positive electrode active material is formed on the positive electrode current collector. As the binder, a high molecular compound having a softening point lower than or equal to the softening point of the ion-conductive high molecular compound included in the electrolyte, as described in this embodiment, can be used as appropriate.

Next, as described in the step S311 in FIG. 2, the positive electrode, the electrolyte, and the negative electrode are stacked in this order, and the electrolyte is sandwiched between the positive electrode and the negative electrode.

Next, as described in the step S321, charge and discharge is conducted once while the power storage cell is being heated. In this case, the power storage cell is heated at temperatures higher than the softening point of the ion-conductive high molecular compound included in the electrolyte. Through these steps, the power storage cell can be formed.

In the storage cell formed in this embodiment, by one cycle of charge and discharge during the heat treatment at temperatures higher than the softening point of the ion-conductive high molecular compound included in the electrolyte, the adhesiveness between the electrolyte and the positive and negative electrodes is enhanced. Here, the high molecular compound having a softening point lower than or equal to the softening point of the ion-conductive high molecular compound included in the electrolyte is included in at least one of the positive electrode and the negative electrode as the binder. Therefore, the charge and discharge is conducted once while the power storage cell is being heated at temperatures higher than the softening point of the high molecular compound, so that the binder included in at least one of the positive electrode and the negative electrode and the ion-conductive high molecular compound included in the electrolyte are melted and adhered, which leads to enhancement of the adhesiveness between the positive and negative electrodes and the electrolyte, as compared with that in Embodiment 1. As a result, the resistance at the interface between the electrolyte and the positive and negative electrodes can be reduced. In addition, an inorganic oxide is mixed at more than 30 wt % and 50 wt % or less, preferably from 33 wt % to 50 wt % of the total of the ion-conductive high molecular compound and the inorganic oxide, so that crystallization of the ion-conductive high molecular compound included in the electrolyte can be suppressed, which leads to enhancement of the ion conductivity in the electrolyte. Accordingly, mobile ions can easily move between the positive electrode and the negative electrode, so that the charge-discharge capacity is increased.

### Embodiment 3

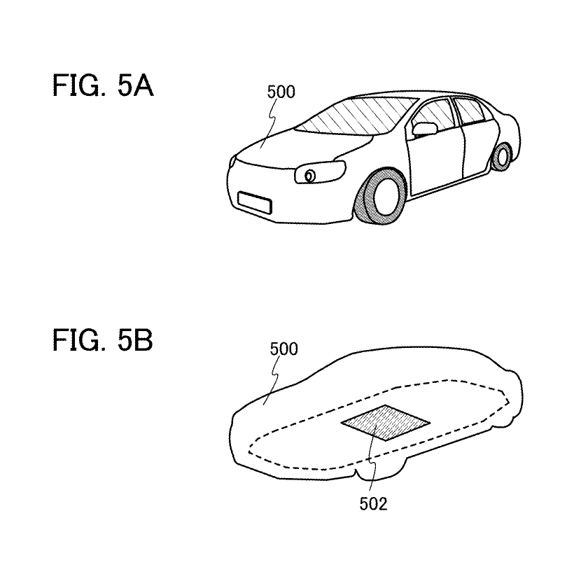

In this embodiment, an application example of the power storage device described in Embodiment 1 or Embodiment 2 will be described with reference to FIGS. 5A and 5B.

The power storage devices described in Embodiment 1 and Embodiment 2 can be used in electronic devices, e.g., cameras such as digital cameras or video cameras, digital photo frames, mobile phones (also referred to as cellular phones or cellular phone devices), portable game machines, portable information terminals, or audio reproducing devices. Further, the power storage device can be used in electric propulsion vehicles such as electric cars, hybrid cars, railway train vehicles, maintenance vehicles, carts, or electric wheelchairs. Here, an example of the electric propulsion vehicle is described.

FIG. 5A illustrates a structure of a four-wheeled automobile 500 as an example of the electric propulsion vehicles. The automobile 500 is an electric vehicle or a hybrid vehicle. An example is illustrated in which the automobile 500 includes a power storage device 502 provided on its bottom portion. In order to clearly show the position of the power storage device 502 in the automobile 500, FIG. 5B shows the outline of the automobile 500 and the power storage device 502 provided on the bottom portion of the automobile 500. The power storage device described in Embodiment 1 or Embodiment 2 can be used as the power storage device 502. The power storage device 502 can be charged by a plug-in technique or a wireless power feeding system, which supplies power from the outside.

### Embodiment 4

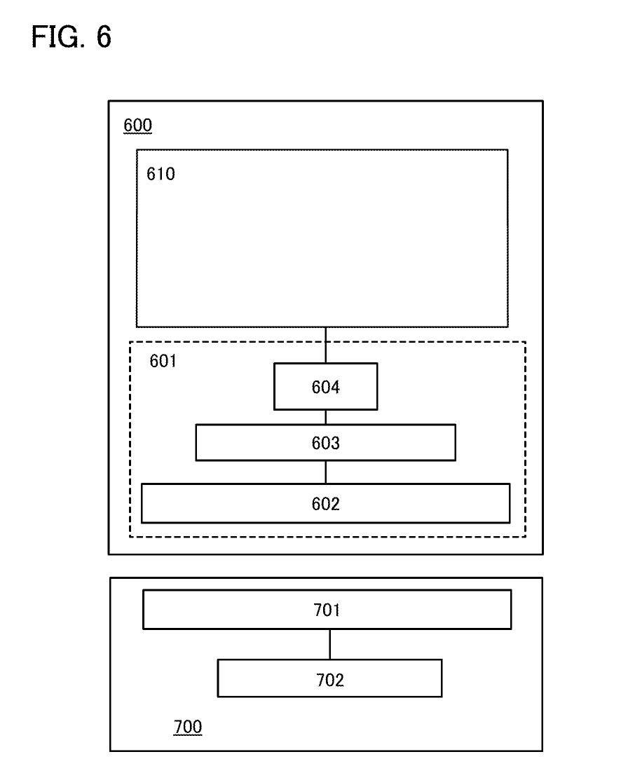

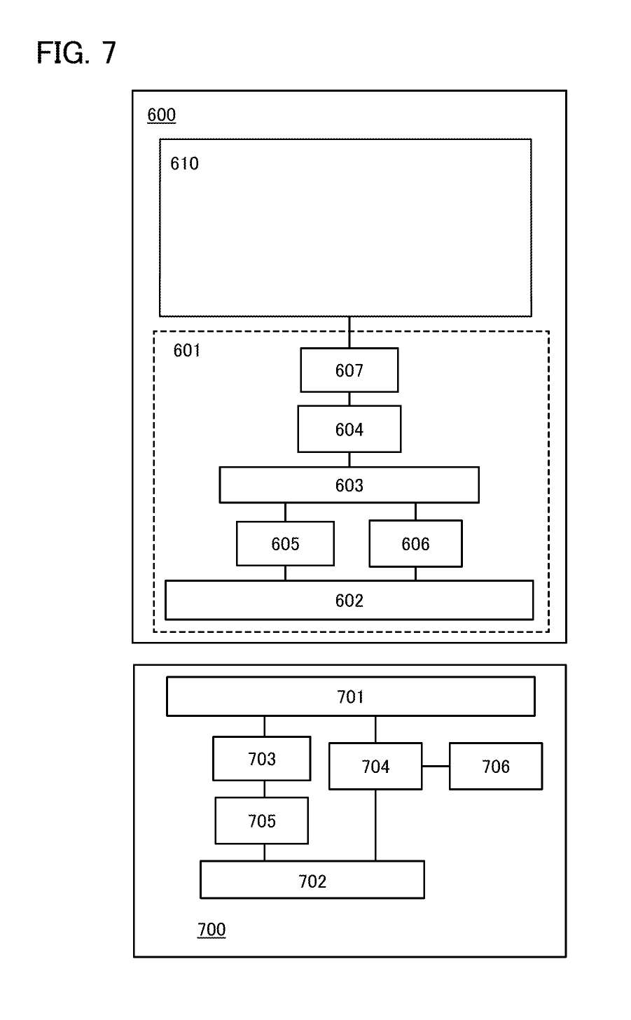

In this embodiment, an example in which a secondary battery that is an example of the power storage device according to one embodiment of the present invention is used in a wireless power feeding system (hereinafter referred to as an RF power feeding system) is described with reference to block diagrams in FIG. 6 and FIG. 7. In each of the block diagrams, blocks show elements independently, which are classified according to their functions, within a power receiving device and a power feeding device. However, it is practically difficult to completely separate the elements according to their functions; in some cases, one element can involve a plurality of functions.

First, the RF power feeding system will be described with reference to FIG. 6.

A power receiving device 600 is an electronic device or an electric propulsion vehicle which is driven by electric power supplied from a power feeding device 700, and can be applied to any other devices which are driven by electric power, as appropriate. Typical examples of the electronic device include cameras such as digital cameras or video cameras, digital photo frames, mobile phones, portable game consoles, portable information terminals, audio reproducing devices, display devices, computers, and the like. Typical examples of the electric propulsion vehicle include electric cars, hybrid cars, railway train vehicles, maintenance vehicles, carts, electric wheelchairs, and the like. In addition, the power feeding device 700 has a function of supplying electric power to the power receiving device 600.

In FIG. 6, the power receiving device 600 includes a power receiving device portion 601 and a power load portion 610. The power receiving device portion 601 includes at least a power receiving device antenna circuit 602, a signal processing circuit 603, and a secondary battery 604. The power feeding device 700 includes at least a power feeding device antenna circuit 701 and a signal processing circuit 702.

The power receiving device antenna circuit 602 has a function of receiving a signal transmitted by the power feeding device antenna circuit 701 or transmitting a signal to the power feeding device antenna circuit 701. The signal processing circuit 603 processes a signal received by the power receiving device antenna circuit 602 and controls charging of the secondary battery 604 and supplying of electric power from the secondary battery 604 to the power load portion 610. In addition, the signal processing circuit 603 controls operation of the power receiving device antenna circuit 602. That is, the signal processing circuit 603 can control the intensity, the frequency, or the like of a signal transmitted by the power receiving device antenna circuit 602. The power load portion 610 is a driving portion which receives electric power from the secondary battery 604 and drives the power receiving device 600. Typical examples of the power load portion 610 include a motor, a driving circuit, and the like. Another device which drives the power receiving device by receiving electric power can be used as the power load portion 610 as appropriate. The power feeding device antenna circuit 701 has a function of transmitting a signal to the power receiving device antenna circuit 602 or receiving a signal from the power receiving device antenna circuit 602. The signal processing circuit 702 processes a signal received by the power feeding device antenna circuit 701. In addition, the signal processing circuit 702 controls operation of the power feeding device antenna circuit 701. That is, the signal processing circuit 702 can control the intensity, the frequency, or the like of a signal transmitted by the power feeding device antenna circuit 701.

The secondary battery according to one embodiment of the present invention is used as the secondary battery 604 included in the power receiving device 600 in the RF power feeding system illustrated in FIG. 6.

By using the secondary battery according to one embodiment of the present invention, for the RF power feeding system, the discharge capacity or the charge capacity (also referred to as the amount of power storage) can be increased as compared with that of a conventional secondary battery. Therefore, since the time interval of the wireless power feeding can be longer, power feeding can be less frequent.

In addition, by using the secondary battery according to one embodiment of the present invention in the RF power feeding system, the power receiving device 600 can be compact and lightweight if the discharge capacity or the charge capacity with which the power load portion 610 can be driven is the same as that of a conventional secondary battery. Therefore, the total cost can be reduced.

Next, another example of the RF power feeding system will be described with reference to FIG. 7.

In FIG. 7, the power receiving device 600 includes the power receiving device portion 601 and the power load portion 610. The power receiving device portion 601 includes at least the power receiving device antenna circuit 602, the signal processing circuit 603, the secondary battery 604, a rectifier circuit 605, a modulation circuit 606, and a power supply circuit 607. In addition, the power feeding device 700 includes at least the power feeding device antenna circuit 701, the signal processing circuit 702, a rectifier circuit 703, a modulation circuit 704, a demodulation circuit 705, and an oscillator circuit 706.

The power receiving device antenna circuit 602 has a function of receiving a signal transmitted by the power feeding device antenna circuit 701 or transmitting a signal to the power feeding device antenna circuit 701. When the power receiving device antenna circuit 602 receives a signal transmitted by the power feeding device antenna circuit 701, the rectifier circuit 605 has a function of generating DC voltage from the signal received by the power receiving device antenna circuit 602. The signal processing circuit 603 has a function of processing a signal received by the power receiving device antenna circuit 602 and controlling charging of the secondary battery 604 and supplying of electric power from the secondary battery 604 to the power supply circuit 607. The power supply circuit 607 has a function of converting voltage stored in the secondary battery 604 into voltage needed for the power load portion 610. The modulation circuit 606 is used when a certain response is transmitted from the power receiving device 600 to the power feeding device 700.

With the power supply circuit 607, electric power supplied to the power load portion 610 can be controlled. Thus, overvoltage application to the power load portion 610 can be inhibited, and deterioration or breakdown of the power receiving device 600 can be inhibited.

In addition, with the modulation circuit 606, a signal can be transmitted from the power receiving device 600 to the power feeding device 700. Therefore, when the amount of charged power in the power receiving device 600 is detected and a certain amount of power is charged, a signal is transmitted from the power receiving device 600 to the power feeding device 700 so that power feeding from the power feeding device 700 to the power receiving device 600 can be stopped. As a result, the secondary battery 604 is not fully charged, so that the number of charge cycles of the secondary battery 604 can be increased.

The power feeding device antenna circuit 701 has a function of transmitting a signal to the power receiving device antenna circuit 602 or receiving a signal from the power receiving device antenna circuit 602. When a signal is transmitted to the power receiving device antenna circuit 602, the signal processing circuit 702 generates a signal which is transmitted to the power receiving device. The oscillator circuit 706 is a circuit which generates a signal with a constant frequency. The modulation circuit 704 has a function of applying voltage to the power feeding device antenna circuit 701 in accordance with the signal generated by the signal processing circuit 702 and the signal with a constant frequency generated by the oscillator circuit 706. Thus, a signal is output from the power feeding device antenna circuit 701. On the other hand, when reception of a signal from the power receiving device antenna circuit 602 is performed, the rectifier circuit 703 has a function of rectifying the received signal. From signals rectified by the rectifier circuit 703, the demodulation circuit 705 extracts a signal transmitted from the power receiving device 600 to the power feeding device 700. The signal processing circuit 702 has a function of analyzing the signal extracted by the demodulation circuit 705.

Note that any circuit may be provided between circuits as long as the RF power feeding can be performed. For example, after the power receiving device 600 receives a signal and the rectifier circuit 605 generates DC voltage, a circuit such as a DC-DC converter or regulator that is provided in a subsequent stage may generate constant voltage. Thus, overvoltage application to the inside of the power receiving device 600 can be inhibited.

A secondary battery according to one embodiment of the present invention is used as the secondary battery 604 included in the power receiving device 600 in the RF power feeding system illustrated in FIG. 7.

By using the secondary battery according to one embodiment of the present invention in the RF power feeding system, the discharge capacity or the charge capacity can be increased as compared with that of a conventional secondary battery; therefore, since the time interval of the wireless power feeding can be longer, power feeding can be less frequent.

In addition, by using the secondary battery according to one embodiment of the present invention in the RF power feeding system, the power receiving device 600 can be compact and lightweight if the discharge capacity or the charge capacity with which the power load portion 610 can be driven is the same as that of a conventional secondary battery. Therefore, the total cost can be reduced.

Note that in the case where the secondary battery according to one embodiment of the present invention is used in the RF power feeding system and the power receiving device antenna circuit 602 and the secondary battery 604 overlap with each other, it is preferred that the impedance of the power receiving device antenna circuit 602 is not changed by deformation of the secondary battery 604 due to charge and discharge of the secondary battery 604 and deformation of an antenna due to the above deformation. If the impedance of the antenna is changed, in some cases, electric power is not supplied sufficiently. For example, the secondary battery 604 may be placed in a battery pack formed of metal or ceramics. Note that in that case, the power receiving device antenna circuit 602 and the battery pack are preferably separated from each other by several tens of micrometers or more.

In this embodiment, the charging signal has no limitation on its frequency and may have any band of frequency with which electric power can be transmitted. For example, the charging signal may have any of an LF band of 135 kHz (long wave), an HF band of 13.56 MHz (short wave), a UHF band of 900 MHz to 1 GHz (ultra high frequency wave), and a microwave band of 2.45 GHz.

A signal transmission method may be properly selected from various methods including an electromagnetic coupling method, an electromagnetic induction method, a resonance method, and a microwave method. In order to prevent energy loss due to foreign substances containing moisture, such as rain and mud, the electromagnetic induction method or the resonance method using a low frequency band, specifically, frequencies of shortwaves of from 3 MHz to 30 MHz, frequencies of medium waves of from 300 kHz to 3 MHz, frequencies of long waves of from 30 kHz to 300 kHz, or frequencies of ultra long waves of from 3 kHz to 30 kHz, is preferably used.

This embodiment can be implemented in combination with any of the above-described embodiments.

### Example 1

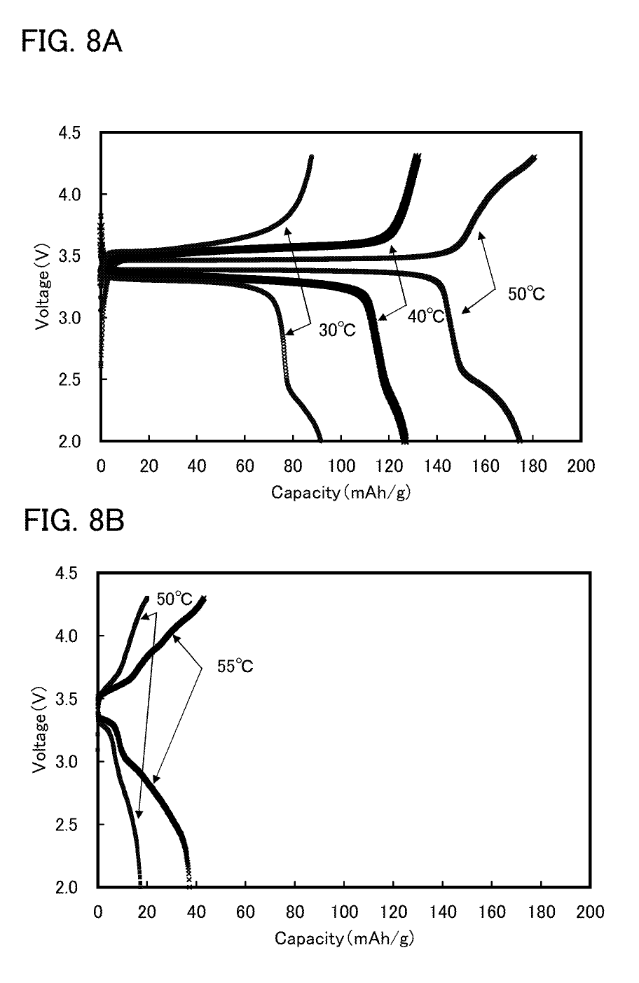

In this example, addition or not of the inorganic oxide in the electrolyte and charge/discharge characteristics of a power storage device are described with reference to FIGS. 8A and 8B.

First, a formation process and a structure of a lithium ion secondary battery as one example of power storage devices are described.

### [Formation Processes and Structures of Electrolytes 1 to 6]

As materials of electrolytes 1 to 6, polyethylene oxide (hereinafter, referred to as PEO and its softening point is from 65 to 67° C.), LiTFSI, and an inorganic oxide including at least one of SiO₂, Li₂O, and Al₂O₃, the weights of which were shown in Table 1, were weighed. Here, the weights of the materials were determined so that the ratio of the oxygen atoms included in PEO to lithium ions included in LiTFSI was 20:1. Next, 15 mL of dehydrated acetonitrile was mixed into each of the mixtures of PEO, LiTFSI, and the inorganic oxide(s), as a solvent, so that a mixture solution was obtained.

Next, glass substrates were prepared and each glass substrate was set in an automatic coating device. Each of the mixture solutions was applied onto the glass substrate. The thickness of the mixture solution applied on the glass substrate was 300 μm.

Next, the substrate was set in a circulation dryer the inside of which is at room temperatures and the mixture solution was dried so that each of the electrolytes 1 to 6 was formed. Table 1 shows the weight ratios of the inorganic oxide(s) to the total of PEO and the inorganic oxide(s) in the electrolytes 1 to 6 and the weight ratios of the inorganic oxides to the electrolytes.

TABLE 1

| | | Inorganic Oxide (IO) | | | | | |
|---|---|---|---|---|---|---|---|
| | PEO | (g) | | | LiTFSI | IO/(IO + PEO) | IO/Electrolyte |
| Electrolyte | (g) | SiO₂ | Li₂O | Al₂O₃ | (g) | (wt %) | (wt %) |
| 1 | 1.0 | 1.0 | 0 | 0 | 0.33 | 50 | 43 |
| 2 | 1.0 | 0.5 | 0 | 0 | 0.33 | 33 | 27 |
| 3 | 1.0 | 0.8 | 0 | 0 | 0.33 | 44 | 38 |
| 4 | 1.0 | 0 | 0.5 | 0 | 0.33 | 33 | 27 |
| 5 | 1.0 | 0.2 | 0.58 | 0.22 | 0.33 | 50 | 43 |
| 6 | 1.0 | 0.1 | 0.29 | 0.11 | 0.33 | 33 | 27 |

Then, after the electrolytes 1 to 6 each were separated of from the glass substrate, a heat treatment was conducted in a vacuum dryer at 80° C. for three hours in the state that each of the electrolytes was sandwiched between the two fluororesin sheets, and thereby the solvents in the electrolytes 1 to 6 were dried. Through these steps, the electrolytes each including PEO, LiTFSI, and the inorganic oxide were obtained.

### [Formation Process and Structure of Electrolyte for Comparison]

1.0 g of PEO and 0.1724 g of LiPF₆ were weighed. Then, a comparative electrolyte including PEO and LiPF₆ was obtained in a process similar to those of the electrolytes 1 to 6.

### [Structure of Positive Electrode]

As materials for the active material layer, 79.4 g of LiFePO₄, 14.8 g of acetylene black, 5.0 g of PEO, and 0.8 g of LiPF₆ were mixed to form shiny.

Then, the slurry is applied on an aluminum foil serving as a current collector and then vacuum drying and heat drying were conducted so that an active material layer was formed. Through these steps, the positive electrode including the active material layer on the current collector was formed.

### [Structure of Negative Electrode]

A lithium foil was prepared as the negative electrode.

### [Process of Forming Secondary Battery]

Next, a process for forming the secondary battery of this example is described.

Any of the electrolytes 1 to 6 or the comparative electrolyte was sandwiched between the positive electrode and the negative electrode so that a secondary battery was formed.

Then, charge-discharge characteristics of the secondary battery were measured. Electric characteristics at this time are shown in FIGS. 8A and 8B.

FIG. 8A shows the relations between capacities and voltages when charge and discharge of the second battery having the electrolyte 1 (hereinafter, the battery is referred to as a secondary battery 1) were conducted at 40° C. or 50° C., and when charge and discharge of the second battery having the electrolyte 2 (hereinafter, the battery is referred to as a secondary battery 2) was conducted at 30° C. Note that FIG. 8A shows measurement results at the third cycle of charge and discharge in each secondary battery after two cycles of charge and discharge.

As shown in FIG. 8A, the discharge capacity of the secondary battery 1 under the condition of charge and discharge at 50° C. was 187 mAh/g, which was higher than 170 mAh/g as a theoretical discharge capacity of the positive electrode (LiFePO₄). In addition, the discharge capacity of the secondary battery 1 under the condition of charge and discharge at 40° C. was 133 mAh/g, and the discharge capacity of the secondary battery 2 under the condition of charge and discharge at 30° C. was 92 mAh/g.

On the other hand, FIG. 8B shows charge-discharge characteristics of the comparative secondary battery using the comparative electrolyte. FIG. 8B shows the relations between capacities and voltages when charge and discharge were performed at 50° C., and 55° C.

The discharge capacity under the condition of charge and discharge at 55° C. was 76 mAh/g and the discharge capacity under the condition of charge and discharge at 50° C. was 17 mAh/g.

In comparison of FIG. 8A with FIG. 8B, by addition of the inorganic oxide

(here silicon oxide) into the electrolyte at 33 wt % or 50 wt % of the total of PEO and the inorganic oxide, the charge-discharge capacity was dramatically increased even under the condition of the charge and discharge at 50° C. which is lower than the softening point of the ion-conductive high molecular compound, i.e., PEO, included in the electrolyte. In addition, although the detailed data are not shown, relatively high charge-discharge capacities were obtained under the condition of the charge and discharge at 30° C. and 40° C. According to the description made above, it is found that addition of the inorganic oxide into the electrolyte can make the charge-discharge capacity of the secondary battery closer to the theoretical capacity even at temperatures lower than the softening point of the ion-conductive high molecular compound.

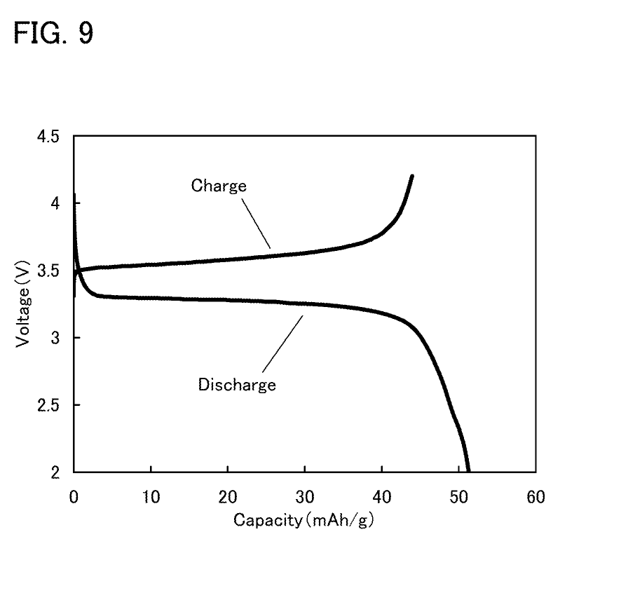

Next, charge-discharge characteristics of a secondary battery having the electrolyte 3 (the battery is referred to as a secondary battery 3) were measured. FIG. 9 shows electric characteristics of the secondary battery 3. Here, the secondary battery 3 was kept at 50° C. for one hour, charge and discharge were conducted once at room temperatures, and thus the active material layer of each electrode and the electrolyte were adhered to each other, and charge and discharge were conducted two more cycles at room temperatures, and then charge and discharge was conducted at room temperatures again (the fourth cycle). The obtained measurement result at the fourth cycle is shown in FIG. 9.

As shown in FIG. 9, the discharge capacity of the secondary battery 3 that was charged and discharged at room temperatures was 51 mAh/g.

From the result shown in FIG. 9, by addition of the inorganic oxide (here silicon oxide) to the electrolyte at 44 wt % of the total of PEO and the inorganic oxide, charge-discharge capacity was obtained at the charge and discharge even at room temperatures.

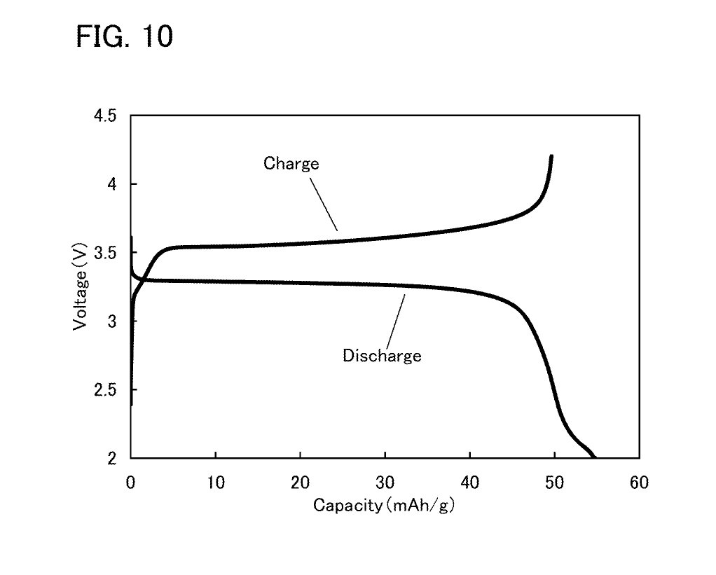

Next, charge-discharge characteristics of a secondary battery having the electrolyte 4 (the battery is referred to as a secondary battery 4) were measured. FIG. 10 shows electric characteristics of the secondary battery 4. Here, the same process as that of the secondary battery 3 was conducted and a measurement result obtained at the fourth cycle of charge and discharge is shown.

As shown in FIG. 10, the discharge capacity of the secondary battery 4 that was charged and discharged at room temperatures was 55 mAh/g.

From the result shown in FIG. 10, by addition of the inorganic oxide (here lithium oxide) to the electrolyte at 33 wt % of the total of PEO and the inorganic oxide, charge-discharge capacity was obtained at the charge and discharge even at room temperatures.

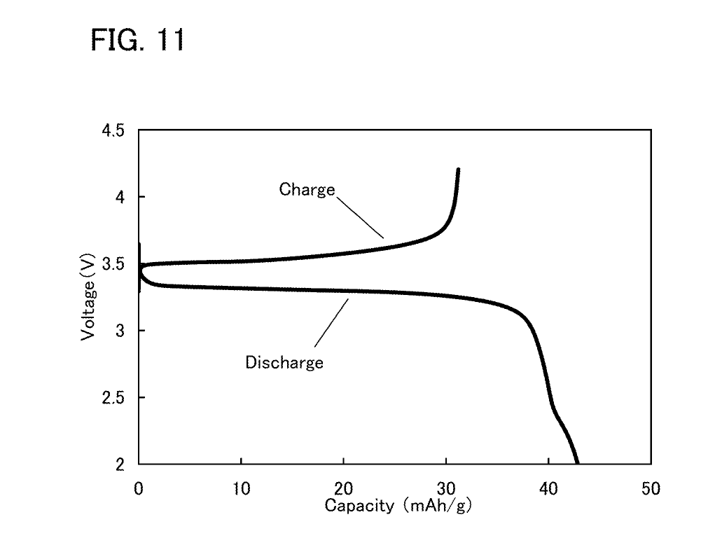

Next, charge-discharge characteristics of a secondary battery having the electrolyte 5 (the battery is referred to as a secondary battery 5) were measured. FIG. 11 shows electric characteristics of the secondary battery 5. Here, the same process as that of the secondary battery 3 was conducted and a measurement result obtained at the fourth cycle of charge and discharge is shown.

As shown in FIG. 11, the discharge capacity of the secondary battery 5 that was charged and discharged at room temperatures was 43 mAh/g.

From the result shown in FIG. 11, by addition of the inorganic oxides (here silicon oxide, lithium oxide, and aluminum oxide) to the electrolyte at 50 wt % of the total of PEO and the inorganic oxides, charge-discharge capacity was obtained at the charge and discharge even at room temperatures.

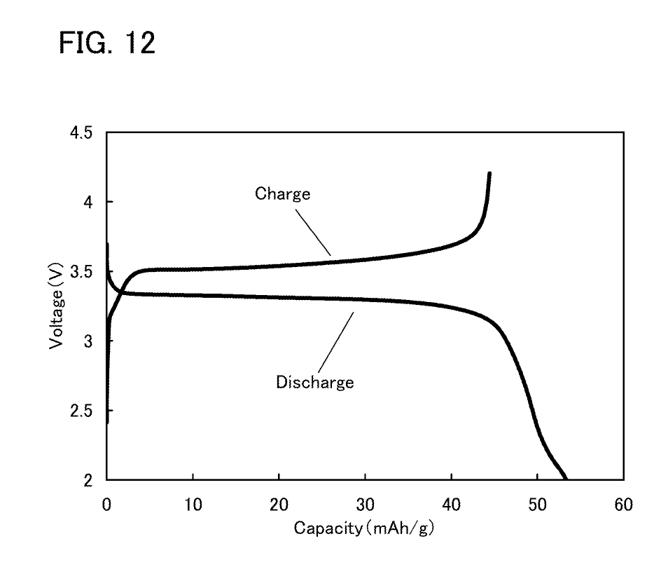

Next, charge-discharge characteristics of a secondary battery having the electrolyte 6 (the battery is referred to as a secondary battery 6) were measured. FIG. 12 shows electric characteristics of the secondary battery 6. Here, the same process as that of the secondary battery 3 was conducted and a measurement result obtained at the fourth cycle of charge and discharge is shown.

As shown in FIG. 12, the discharge capacity of the secondary battery 6 that was charged and discharged at room temperatures was 53 mAh/g.

From the result shown in FIG. 12, by addition of the inorganic oxides (here silicon oxide, lithium oxide, and aluminum oxide) to the electrolyte at 33 wt % of the total of PEO and the inorganic oxides, charge-discharge capacity was obtained at the charge and discharge even at room temperatures.

In other words, each of the secondary batteries that includes an electrolyte where an inorganic oxide is included at from 33 wt % to 50 wt % of the total of an ion-conductive high molecular compound and the inorganic oxide can obtain charge and charge-discharge capacity even at temperatures lower than the softening point of the ion-conductive high molecular compound and further can be charged and discharged at room temperatures.

### Example 2

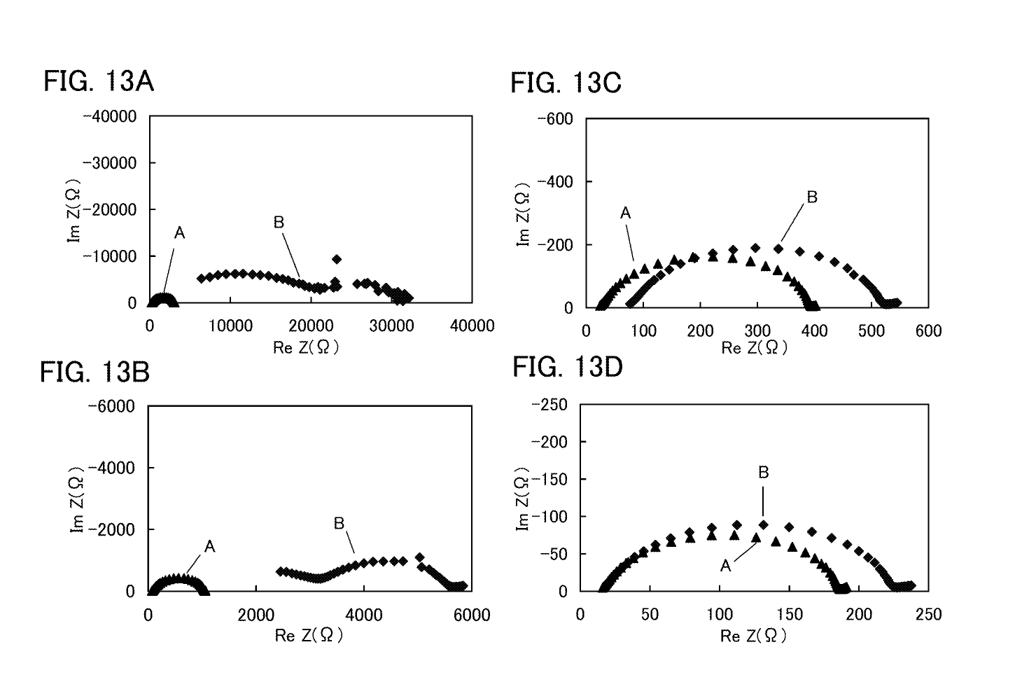

In this example, addition or not of the inorganic oxide in the electrolyte and resistance at the interface between the electrolyte and the positive and negative electrodes are described with reference to FIGS. 13A and 13B.

First, a method for forming a secondary battery is described below.

As materials of the electrolyte, 1.0 g of PEO, 0.1724 g of LiPF₆, and 1.0 g of silicon oxide were weighed, and then in a manner similar to that in Example 1, the electrolyte was formed. In addition, the electrolyte was sandwiched between the positive electrode and the negative electrode similar to those in Example 1, and thereby the battery cell was formed.

Then, while the battery cell was being kept at 70° C., charge and discharge was conducted once, and thereby the secondary battery was formed.

Next, a method for forming a comparative secondary battery is described below.

Silicon oxide was excluded from the materials of the electrolyte described above, and 1.0 g of PEO and 0.1724 g of LiPF₆ were weighed as the materials of the comparative electrolyte. Then, the comparative electrolyte was formed in a manner similar to that in Example 1. In addition, the comparative electrolyte was sandwiched between the positive electrode and the negative electrode similar to those in Example 1, and thereby the comparative battery cell was formed.

Then, while the battery cell was being kept at 70° C., charge and discharge was conducted once, and thereby the comparative secondary battery was formed.

Next, while the secondary battery and the comparative secondary battery were each being kept at 40° C., 50° C., 60° C., and 70° C., the impedance of each secondary battery was measured. Here, with use of an electrochemical measuring system, HZ-5000, manufactured by Hokuto Denko Corporation, an AC impedance measurement by constant potential was conducted. The measurement conditions were as follows: the initial frequency was 20 kHz, AC amplitude was 10 mV, the last frequency was 100 mHz, the measurement time was 1 hour, and the sampling interval was 10 seconds.

FIGS. 13A, 13B, 13C, and 13D show measurement results at 40° C., 50° C., 60° C., and 70° C. respectively. In addition, in each graph, the triangles A show the impedance Z of the secondary battery, and the rhombuses B show the impedance Z of the comparative secondary battery. The horizontal axes show the real parts of the impedances Z whereas the vertical axes show the imaginary parts of the impedances Z.

FIGS. 13A, 13B, 13C, and 13D reveal that the real parts of the impedances Z of the secondary battery become lower than those of the comparative secondary battery. In particular, as shown in FIG. 13A and FIG. 13B, the real parts of impedances Z are more decreased at 40° C. and 50° C., which are temperatures lower than the softening point of PEO.

These results reveal that addition of the inorganic oxide to the electrolyte can decrease the resistance at the interface between the electrolyte and the positive and the negative electrodes. In addition, it is found that by one cycle of charge and discharge at temperatures higher than the softening point of the ion-conductive high molecular compound, i.e., PEO, the resistance at the interface between the electrolyte and the positive and negative electrodes can be lowered.

### REFERENCE NUMERALS

100: power storage device, 101: negative electrode, 102: negative electrode current collector, 103: negative electrode active material layer, 111: positive electrode, 112: positive electrode current collector, 113: positive electrode active material layer, 121: electrolyte, 500: automobile, 502: power storage device, 600: power receiving device, 601: power receiving device portion, 602: power receiving device antenna circuit, 603: signal processing circuit, 604: secondary battery 605: rectifier circuit, 606: modulation circuit, 607: power supply circuit, 610: power load portion, 700: power feeding device, 701: power feeding device antenna circuit, 702: signal processing circuit, 703: rectifier circuit, 704: modulation circuit, 705: demodulation circuit, 706: oscillator circuit.

This application is based on Japanese Patent Application serial no. 2010-275838 filed with Japan Patent Office on Dec. 10, 2010 the entire contents of which are hereby incorporated by reference.

1. A power storage device comprising:
a positive electrode;
a negative electrode;
an electrolyte between the positive electrode and the negative electrode,
wherein:
the electrolyte includes an ion-conductive high molecular compound, an inorganic oxide, and a lithium salt; and
the inorganic oxide is included in the electrolyte at more than 30 wt % and 50 wt % or less to the total of the ion-conductive high molecular compound and the inorganic oxide.

2. The power storage device according to claim 1, wherein at least one of the positive electrode and the negative electrode includes an active material layer over a current collector.

3. The power storage device according to claim 1, wherein the ion-conductive high molecular compound is a polyalkylene oxide.

4. The power storage device according to claim 3, wherein the polyalkylene oxide is one selected from the group consisting of polyethylene oxide and polypropylene oxide.

5. The power storage device according to claim 1, wherein the inorganic oxide is selected from the group consisting of silicon oxide, titanium oxide, zirconium oxide, aluminum oxide, zinc oxide, iron oxide, cerium oxide, magnesium oxide, antimony oxide, germanium oxide, lithium oxide, graphite oxide, barium titanate, lithium metasilicate, and a combination thereof.

6. The power storage device according to claim 1, wherein the lithium salt is selected from the group consisting LiCF₃SO₃, LiPF₆, LiBF₄, LiSCN, LiN(C₂F₅SO₂)₂, LiN(CF₃SO₂)₂, LiClO₄, and a combination thereof.

7. The power storage device according to claim 2, wherein the active material layer includes the ion-conductive high molecular compound.

8. A method for manufacturing a power storage device comprising:
mixing an ion-conductive high molecular compound, an inorganic oxide, and a lithium salt for forming slurry;
coating a substrate with the slurry;
drying the slurry for forming an electrolyte;
separating the electrolyte from the substrate; and
sandwiching the electrolyte between a positive electrode and a negative electrode,
wherein the inorganic oxide is included in the electrolyte at more than 30 wt % and 50 wt % or less to the total of the ion-conductive high molecular compound and the inorganic oxide.

9. The method for manufacturing a power storage device according to claim 8, wherein at least one of the positive electrode and the negative electrode includes an active material layer over a current collector.

10. The method for manufacturing a power storage device according to claim 8, wherein the ion-conductive high molecular compound is a polyalkylene oxide.

11. The method for manufacturing a power storage device according to claim 10, wherein the polyalkylene oxide is selected from the group consisting of polyethylene oxide, polypropylene oxide, and a combination thereof.

12. The method for manufacturing a power storage device according to claim 8, wherein the inorganic oxide is selected from the group consisting of silicon oxide, titanium oxide, zirconium oxide, aluminum oxide, zinc oxide, iron oxide, cerium oxide, magnesium oxide, antimony oxide, germanium oxide, lithium oxide, graphite oxide, barium titanate, lithium metasilicate, and a combination thereof.

13. The method for manufacturing a power storage device according to claim 8, wherein the lithium salt is selected from the group consisting LiCF₃SO₃, LiPF₆, LiBF₄, LiSCN, LiN(C₂F₅SO₂)₂, LiN(CF₃SO₂)₂, LiClO₄, and a combination thereof.

14. The method for manufacturing a power storage device according to claim 9, wherein the active material layer includes the ion-conductive high molecular compound.

15. A method for manufacturing a power storage device comprising:
mixing an ion-conductive high molecular compound, an inorganic oxide, and a lithium salt for forming slurry;
drying the slurry for forming an electrolyte;
adhering the electrolyte with one of a positive electrode and a negative electrode for forming a power storage cell; and
charging and discharging the power storage cell at a temperature higher than a softening temperature of the ion-conductive high molecular compound.

16. The method for manufacturing a power storage device according to claim 15, wherein at least one of the positive electrode and the negative electrode includes an active material layer over a current collector.

17. The method for manufacturing a power storage device according to claim 15, wherein the ion-conductive high molecular compound is a polyalkylene oxide.

18. The method for manufacturing a power storage device according to claim 17, wherein the polyalkylene oxide is one selected from the group consisting of polyethylene oxide and polypropylene oxide.

19. The method for manufacturing a power storage device according to claim 15, wherein the inorganic oxide is selected from the group consisting of silicon oxide, titanium oxide, zirconium oxide, aluminum oxide, zinc oxide, iron oxide, cerium oxide, magnesium oxide, antimony oxide, germanium oxide, lithium oxide, graphite oxide, barium titanate, lithium metasilicate, and a combination thereof.

20. The method for manufacturing a power storage device according to claim 15, wherein the lithium salt is selected from the group consisting LiCF₃SO₃, LiPF₆, LiBF₄, LiSCN, LiN(C₂F₅SO₂)₂, LiN(CF₃SO₂)₂, and LiClO₄, and a combination thereof.
